(19) United States
(12) Patent Application Publication
(10) Pub. No.: US 2015/0156382 A1
(43) Pub. Date: Jun. 4, 2015

(54) MULTI-CHANNEL GLARE-SUPPRESSION DEVICE OF A DIGITAL IMAGE SYSTEM

(71) Applicant: Chung-Shan Institute of Science and Technology, Armaments Bureau, M.N.D, Taoyuan County (TW)

(72) Inventors: Chih-Wei Kuo, Taoyuan County (TW); Er-Liang Jian, Taoyuan County (TW); Min-Fang Lo, Taoyuan County (TW); Shao-Chung Hu, Taoyuan County (TW)

(73) Assignee: Chung-Shan Institute of Science and Technology, Armaments Bureau, M.N.D, Taoyuan County (TW)

(21) Appl. No.: 14/095,028

(22) Filed: Dec. 3, 2013

(51) Int. Cl. H04N 5/225; H04N 5/232

(52) U.S. Cl. CPC H04N 5/2256; H04N 5/23212

(57) ABSTRACT

A multi-channel glare-suppression device of a digital image system first acquires a spatial image, and at least one first lens set then collects light from the spatial image and generates an optical image. The optical image then passes through or is reflected by an optical modulation module to generate a modulated image. At least one second lens set further scales the modulated image and focuses the modulated image to generate a scaled image on a photo-sensing module for the photo-sensing module to convert the scaled image into an image signal. A processing module senses the photo-sensing module. When detecting a current higher than a threshold generated in a region of the photo-sensing module, the processing module then generates the control signal to modulate a region of the modulated image so as to attenuate the glare in the region of the modulated image.

### BACKGROUND OF THE INVENTION

1. Field of the Invention

The present invention relates to a multi-channel glare-suppression device of a digital image system, and, more particularly, to a multi-channel glare-suppression device of a digital image system using a multi-channel optical modulation module to perform light intensity modulation of image signals.

2. Description of the Related Art

During an imaging process of a digital image, glare oftentimes arises because of exposure to high ambient light intensity. Regular glare-suppression approaches primarily include the use of optical full-field measurement, electronic hardware and software algorithm.

The approach of optical full-field measurement is performed by a filtering lens mounted on a lens to achieve a function of suppressing glare. However, such approach lowers light intensity of light sources in the environment, and is not preferred accordingly. The approach using electronic hardware to suppress glare adds an adjustment unit for each light-sensing element to independently configure a time for obtaining an integral of intensity of each pixel of an image to be taken, rendering the approach only applicable to occasions having light sources with higher light intensity. However, such approach usually causes lower intensity of pixels in the image and is therefore not ideal enough. The approach using software algorithm to suppress glare needs image manipulation software, such as mask operation of digital image, a thresholding operation for reducing intensities of pixels higher than a threshold, and the like, to combine and average images taken with different exposure times before imaging. However, such approach lowers resolution of images and takes longer time for computation.

### SUMMARY OF THE INVENTION

An objective of the present invention is to provide a multi-channel glare suppression device of a digital image system using a multi-channel optical modulation to suppress glare through light intensity modulation of an image.

To achieve the foregoing objective, the multi-channel glare-suppression device of a digital image system has at least one first lens set, a multi-channel optical modulation module, at least one second lens set, a photo-sensing module and a processing module.

The at least one first lens set collects light from a spatial image and generates an optical image.

The multi-channel optical modulation module is penetrated through by or reflects the optical image to generate a modulated image.

The at least one second lens set receives the modulated image and focuses the modulated image to generate a scaled image.

The photo-sensing module receives the scaled image and converts the scaled image into an image signal.

The processing module is electrically connected to the multi-channel optical modulation module and the photo-sensing module, senses the photo-sensing module, and generates a control signal when detecting a current higher than a threshold in a region of the photo-sensing module to instruct the multi-channel optical modulation module to modulate a region in the modulated image corresponding to the region of the photo-sensing module so as to attenuate glare higher than an light intensity in the region of the modulated image.

Another objective of the present invention is to provide a multi-channel glare suppression device of a digital image system promptly and inexpensively suppressing glare in an image by means of hardware.

To achieve the foregoing objective, the multi-channel glare-suppression device of a digital image system has at least one first lens set, at least one second lens set, a multi-channel optical modulation module, a photo-sensing module and a processing module.

The at least one first lens set performs a first light collection and a first image scaling on the spatial image and generates an optical image.

The at least one second lens set performs a second light collection and a second image scaling on the optical image to generate a scaled image.

The multi-channel optical modulation module receives the scaled image for the scaled image to penetrate through the multi-channel optical modulation module and generate a modulated image.

The photo-sensing module receives the scaled image and converts the scaled image into an image signal.

The processing module is electrically connected to the multi-channel optical modulation module and the photo-sensing module, senses the photo-sensing module, and generates a control signal when detecting a current higher than a threshold in a region of the photo-sensing module to instruct the multi-channel optical modulation module to modulate a region in the modulated image corresponding to the region of the photo-sensing module so as to attenuate glare higher than an light intensity in the region of the modulated image.

### BRIEF DESCRIPTION OF THE DRAWINGS

The invention, as well as its many advantages, may be further understood by the following detailed description and drawings in which:

FIG. 1 is a schematic view of a first embodiment of a multi-channel glare-suppression device of a digital image system in accordance with the present invention;

FIG. 2 is a schematic view of a second embodiment of a multi-channel glare-suppression device of a digital image system in accordance with the present invention; and

FIG. 3 is a schematic view of a third embodiment of a multi-channel glare-suppression device of a digital image system in accordance with the present invention.

### DETAILED DESCRIPTION OF THE INVENTION

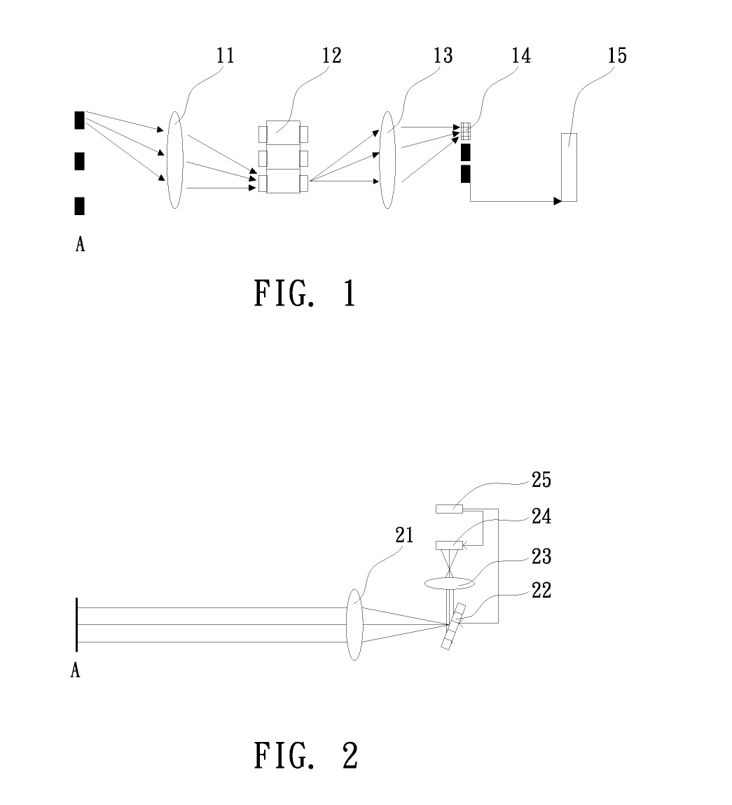

With reference to FIG. 1, a first embodiment of a multi-channel glare-suppression device of a digital image system in accordance with the present invention has at least one first lens set 11, a multi-channel optical modulation module 12, at least one second lens set 13, a photo-sensing module 14 and a processing module 15.

The at least one lens set 11 collects light from a spatial image, and generates an optical image A′, and is an objective lens formed by multiple lens.

The multi-channel optical modulation module 12 is provided for the optical image A′ to pass through or reflects the optical image A′, so as to generate a modulated image A″. The optical modulation module 12 may be a transmissive liquid crystal element or a liquid crystal on silicon (LCOS).

The at least one second lens set 13 serves to receive the modulated image A″ and focus the modulated image A″ to generate a scaled image A′″. The at least one second lens set 13 is a scaling lens formed by multiple lens.

The photo-sensing module 14 serves to receive the scaled image A′″ and generate an image signal according to the scaled image A′″.

The processing module 15 is electrically connected to the optical modulation module 12 and the photo-sensing module 14 and senses the photo-sensing module. When the processing module 15 senses a current that is higher than a threshold and is generated in a region of the photo-sensing module 14, it indicates that high-intensity glare takes place in the region, and the processing module 15 generates a control signal so that the multi-channel modulation module 12 modulates a region inside the modulated image A″ corresponding to the region inside the photo-sensing module 14 to attenuate the high-intensity glare in the region of the modulated image A″.

In the present embodiment, the at least one second lens set 13 serves to focus and scale the modulated image so as to generate a scaled image on the photo-sensing module 14. The photo-sensing module 14 may be a charge-coupled device (CCD) image sensing element or a complementary metal oxide semiconductor (CMOS) image sensing element.

The spatial image A is easily affected by lighting, vehicular headlight, and the like in the nearby outdoors or indoors during nighttime to result in high-intensity glare thereon partially. When the multi-channel glare-suppression device of a digital image system performs image acquisition on the spatial image A, the at least one first lens set 11 generates the optical image A′ after collecting light from the spatial image A. The optical image A′ then passes through the multi-channel optical modulation module 12 to generate the modulated image A″. Subsequently, the at least one second lens set 13 performs image scaling on the modulated image A″, and focuses the modulated image A″ to generate the scaled image A′″ that is projected onto the photo-sensing module 14. When the scaled image A′″ is projected onto the photo-sensing element 14, the processing module 15 senses the photo-sensing module 14. When detecting that there is a current higher than a threshold generated in a region of the photo-sensing module 14, indicating that high-intensity glare exists in the region, the processing module 15 generates the control signal to instruct the multi-channel optical modulation module 12 to modulate a region of the modulated image A″ corresponding to the region in the photo-sensing module 14 for attenuating the high-intensity glare in the region of the modulated image A″. Lastly, glare existing in the image signal affecting the image quality demonstrated by the image signal is reduced, thereby achieving the objective of suppressing glare in an image using hardware means, and providing a fast and low-cost glare-suppression solution.

Moreover, the multi-channel optical modulation module 12 can be changed from the transmissive liquid crystal element to an LCOS. With reference to FIG. 2, a second embodiment of a multi-channel glare-suppression device of a digital image system in accordance with the present invention has at least one first lens set 21, a multi-channel optical modulation module 22, at least one second lens set 23, a photo-sensing module 24 and a processing module 25.

The multi-channel optical modulation module 22 is an LCOS. According to the concept of the present invention, the multi-channel optical modulation module 22, the at least one second lens set 23 and the photo-sensing module 24 can be arranged on different locations depending on an optical path of the multi-channel optical modulation module 22, the at least one second lens set 23 and the photo-sensing module 24. When the multi-channel glare-suppression device of a digital image system performs image acquisition, the at least one first lens set 21 collects light from a spatial image A and then generates an optical image A′. The optical image A′ is reflected by the multi-channel optical modulation module to generate a modulated image A″ on the at least one second lens set 23 for the at least one second optical lens 23 to perform image scaling on the modulated image A″ and to focus the modulated image A″ to generate a scaled image A′″ on the photo-sensing module 24. The photo-sensing module 24 converts the scaled image A′″ into an image signal. The processing module 25 senses the photo-sensing module 24, and generates a control signal to instruct the multi-channel optical modulation module 22 to modulate a region in the modulated image A″ corresponding to the region in the photo-sensing module 24 when detecting a current higher than a threshold generated in a region of the photo-sensing module 24, indicating that high-intensity glare occurs on the region. Accordingly, the high-intensity glare in the region of the modulated image A″ can be attenuated to finally reduce the intensity of glare in the image signal and improve image quality demonstrated by the image signal.

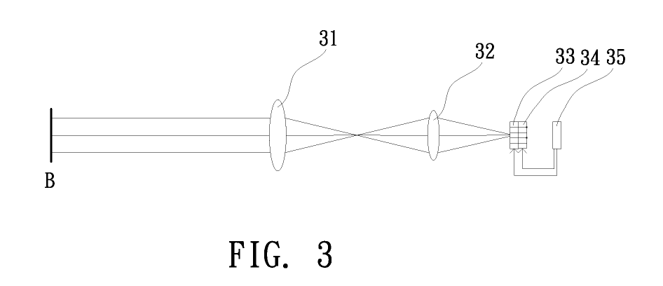

With reference to FIG. 3, a third embodiment of a multi-channel glare-suppression device of a digital image system in accordance with the present invention has at least one lens set 31, at least one second lens set 32, a multi-channel optical modulation module 33, a photo-sensing module 34 and a processing module 35.

The optical modulation module 33 is mounted between the at least one second lens set 32 and the photo-sensing module 34. When the multi-channel glare-suppression device of a digital image system performs image acquisition and collects light from a spatial image B, the first lens set 31 performs a first light collection and a first image scaling on the spatial image B and then generates an optical image B′. The at least one second lens set 32 performs a second light collection and a second image scaling on the optical image B′ to generate a scaled image B″. The scaled image B″ passes through the multi-channel optical modulation module 33 to generate a modulated image B′″ on the photo-sensing module 34. The photo-sensing module 34 converts the scaled image B′″ into an image signal. The processing module 35 senses the photo-sensing module 34, and generates a control signal to instruct the multi-channel optical modulation module 33 to modulate a region in the modulated image B″ corresponding to the region in the photo-sensing module 34 when detecting a current higher than a threshold generated in a region of the photo-sensing module 34, indicating that high-intensity glare occurs on the region. Accordingly, the high-intensity glare in the region of the modulated image B″ can be attenuated to finally reduce the intensity of glare in the image signal and improve image quality demonstrated by the image signal.

From the foregoing, after the multi-channel glare-suppression device of a digital image system acquires the spatial image A, the at least one first lens set 11 collects light from the spatial image A and generates the optical image A′. The optical image A′ then passes through or is reflected by the optical modulation module 12 to generate the modulated image A″. The at least one second lens set 13 further scales the modulated image A″ and focuses the modulated image A″ to generate the scaled image A′″ on the photo-sensing module 14 for the photo-sensing module 14 to convert the scaled image A′″ into the image signal. Meanwhile, the processing module 15 senses the photo-sensing module. When detecting a current higher than a threshold generated in a region of the photo-sensing module 14, indicating that high-intensity glare occurs in the region, the processing module 15 generates the control signal to instruct the multi-channel optical modulation module 12 to modulate a region of the modulated image A″ corresponding to the region in the photo-sensing module 14 so as to attenuate the high-intensity glare in the region of the modulated image A″. Accordingly, the image quality demonstrated by the image signal is not affected the high-intensity glare in the image signal, thereby achieving the object of promptly and inexpensively suppressing glare in an image by means of hardware.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A multi-channel glare-suppression device of a digital image system, comprising:
at least one first lens set collecting light from a spatial image and generating an optical image;
a multi-channel optical modulation module penetrated through by or reflecting the optical image to generate a modulated image;
at least one second lens set receiving the modulated image and focusing the modulated image to generate a scaled image;
a photo-sensing module receiving the scaled image and converting the scaled image into an image signal; and
a processing module electrically connected to the multi-channel optical modulation module and the photo-sensing module, sensing the photo-sensing module, and generating a control signal when detecting a current higher than a threshold in a region of the photo-sensing module to instruct the multi-channel optical modulation module to modulate a region in the modulated image corresponding to the region of the photo-sensing module so as to attenuate glare higher than an light intensity in the region of the modulated image.

2. The multi-channel glare-suppression device as claimed in claim 1, wherein the at least one first lens is an objective lens formed by multiple lens.

3. The multi-channel glare-suppression device as claimed in claim 1, wherein the multi-channel optical modulation module is a transmissive liquid crystal element.

4. The multi-channel glare-suppression device as claimed in claim 1, wherein the multi-channel optical modulation module is a liquid crystal on silicon.

5. The multi-channel glare-suppression device as claimed in claim 1, wherein the at least one second lens set is a scaling lens formed by multiple lens.

6. The multi-channel glare-suppression device as claimed in claim 1, wherein the photo-sensing module is a charge-coupled device (CCD) image sensing element.

7. The multi-channel glare-suppression device as claimed in claim 1, wherein the photo-sensing module is a complementary metal oxide semiconductor (CMOS) image sensing element.

8. A multi-channel glare-suppression device of a digital image system, comprising:
at least one first lens set performing a first light collection and a first image scaling on a spatial image and generating an optical image;
at least one second lens set performing a second light collection and a second image scaling on the optical image to generate a scaled image;
a multi-channel optical modulation module receiving the scaled image for the scaled image to penetrate through the multi-channel optical modulation module and generate a modulated image;
a photo-sensing module receiving the scaled image and converting the scaled image into an image signal; and
a processing module electrically connected to the multi-channel optical modulation module and the photo-sensing module, sensing the photo-sensing module, and generating a control signal when detecting a current higher than a threshold in a region of the photo-sensing module to instruct the multi-channel optical modulation module to modulate a region in the modulated image corresponding to the region of the photo-sensing module so as to attenuate glare higher than an light intensity in the region of the modulated image.

9. The multi-channel glare-suppression device as claimed in claim 8, wherein the at least one first lens is an objective lens formed by multiple lens.

10. The multi-channel glare-suppression device as claimed in claim 8, wherein the multi-channel optical modulation module is a transmissive liquid crystal element.

11. The multi-channel glare-suppression device as claimed in claim 8, wherein the multi-channel optical modulation module is a liquid crystal on silicon.

12. The multi-channel glare-suppression device as claimed in claim 8, wherein the at least one second lens set is a scaling lens formed by multiple lens.

13. The multi-channel glare-suppression device as claimed in claim 8, wherein the photo-sensing module is a charge-coupled device (CCD) image sensing element.

14. The multi-channel glare-suppression device as claimed in claim 8, wherein the photo-sensing module is a complementary metal oxide semiconductor (CMOS) image sensing element.
